(19) United States
(12) Patent Application Publication
(10) Pub. No.: US 2024/0362359 A1
(43) Pub. Date: Oct. 31, 2024

(54) PRIVACY CONTROLS FOR GEOSPATIAL MESSAGING

(71) Applicant: GOOGLE LLC, Mountain View, CA (US)

(72) Inventors: Kathleen Alexandra Bryan, Mountain View, CA (US); Shiblee Hasan, Santa Clara, CA (US)

(21) Appl. No.: 18/308,428

(22) Filed: Apr. 27, 2023

(51) Int. Cl. G06F 21/62; H04L 51/222

(52) U.S. Cl. CPC G06F 21/6245; H04L 51/222

(57) ABSTRACT

A device may include a processor. A device may include a memory configured with instructions to: receive an information disclosure level selected by a user, the information disclosure level relating to at least one sensor recording a real-world environment around the user, receive sensor information from the at least one sensor, filter the sensor information based on the information disclosure level to generate a subset of sensor information; and send the subset of sensor information to a second device.

### TECHNICAL FIELD

This description relates to providing privacy controls for geospatial messaging.

### BACKGROUND

Messages from other users can be viewed in an augmented reality system. However, known systems may be limited in the manner in which messages from other users are displayed.

### SUMMARY

The present disclosure describes a way for a first user to control the information that a second user can access about what is in the field of view and environment around the first user when the second user creates a custom geomessage that will be displayed on the first user's head mounted device. The geomessage created by the second user includes content and is associated with a selected environmental feature. The content may include any combination of image, text, and audio. In some implementations, a geomessage (also referred to as geospatial messaging) is a message created by a sending user that can be viewed on augmented reality glasses worn by the receiving user. The degree of personalization of the geospatial messaging depends on how precisely the sending user can associate the geomessage with an environmental feature, or a physical real-world object, condition, or context in the field of view of the receiving user.

In some aspects, the techniques described herein relate to a computing device including: a processor; and a memory configured with instructions to: receive an information disclosure level selected by a user, the information disclosure level relating to at least one sensor recording an environment around the user; receive sensor information from the at least one sensor; filter the sensor information based on the information disclosure level to generate a subset of sensor information; and send the subset of sensor information to a second device.

In some aspects, the techniques described herein relate to a computing device including: a processor; and a memory configured with instructions to: receive a subset of sensor information from a first device, the subset of sensor information being based on at least one sensor proximate to a first device and an information disclosure level; receive a content generated by a user; receive a selected environmental feature identified from the subset of sensor information by the user; and send the content to the first device for display in proximity to the selected environmental feature identified from the subset of sensor information.

In some aspects, the techniques described herein relate to a method, including: receiving an information disclosure level selected by a user from a first device; receiving sensor information from at least one sensor from the first device; and sending a subset of sensor information to a second device based on the sensor information and the information disclosure level.

### BRIEF DESCRIPTION OF THE DRAWINGS

FIG. 1A depicts a scenario, in accordance with an example.

FIGS. 1B and 1C depict fields of view, in accordance with examples.

FIG. 1D depicts a privacy settings window, in accordance with an example.

FIG. 1E a content generation window, in accordance with an example.

FIGS. 1F and 1G illustrate content association windows, in accordance with examples.

FIG. 2 a head mounted device, in accordance with an example.

FIG. 3A block diagram of a system, in accordance with an example.

FIGS. 3B and 3C illustrate block diagrams of devices, in accordance with examples.

FIG. 3D a block diagram of a server, in accordance with an example.

FIGS. 4A and 4B illustrate flow diagrams, in accordance with examples.

### DETAILED DESCRIPTION

The present disclosure describes an apparatus and method that a first user can use to share information about what is in the environment around them so that a second user can send customized geomessages for display on the first user's head mounted device. In some implementations, the geomessages are associated with real-world environmental features found around the first user. The disclosure provides ways for the first user to control how much information the second user receives about the environment around the first user, thereby providing, for example, at least some level of privacy and privacy control for the first user. The geomessage includes content and/or a selected real-world environmental feature. The content may include, for instance, any combination of image, text, and audio. For example, if a second user wanted to remind a first user to get an oil change after work, the second user could pin a message about the oil change to a wall in a parking garage where the first user's car is parked.

The real-world environmental feature may include any physical feature or context that can be detected and identified within a proximity of a user. For example, the real-world environmental feature may comprise anything from the following non-exclusive list: a location, a person, a type of building, a type of structure, a type of a surface, a lighting environment, a weather type, an object, an event type, a sound, a phrase, and so forth.

In examples, the selected real-world environmental feature may be something already in the field of view of the first user, and therefore the content may be immediately displayed proximate to the selected real-world environmental feature. In other examples, however, the selected real-world environmental feature may be something that may come into the field of view or environment around the first user in the future. In such a case, the content may not be displayed for the user until the selected real-world environmental feature appears around the user. The first user's head mounted device displays the content created by the second user proximate to the real-world environmental feature. In examples where the content includes audio, a speaker associated with the first user's head mounted device or another computing device may play the audio as well.

The second user may be provided with information about what is in the environment or field of view of the first user when generating a geomessage. This may allow the second user to further customize the geomessage by targeting a selected real-world environmental feature. The more information about the environment provided from the first user to the second user, the better the second user can customize the delivery of the content, and possibly the content itself. The first user gets the benefits of a geomessage carefully targeted to a specific real-world environmental feature. For example, if the second user wanted to remind the first user to buy milk on the way home, and the second user knew what part of a city the first user was in and the direction of travel, the second user could pin a geomessage to buy milk on an outside surface of a building where milk is sold that the first user is passing or soon to pass. This may allow for the first user to receive the message at just the right moment, preventing the need to remember to look at a list or visual clutter within the field of view of the second user.

In some circumstances, the first user may want to restrict what the second user may know about the environment in and around him or her. For example, if the first user is in a pharmacy looking for a medication or in a bathroom, the first user may not want the second user to have access to that information. In other circumstances, however, the first user may not feel a need to restrict information about what is in and around their environment. For example, if the first user is at a playground with their child, they may not mind a second user who is a family member learning this or seeing what is around them.

At least one technical problem can be how to get the benefit of allowing the second user to customize a geomessage with a desire to keep some details about the environment around the first user private.

The solutions described herein provide for a user-selectable information disclosure level that a first user may use to designate what information from at least one sensor will be shared with the second user. The at least one sensor detects the physical environment around the user. The first user's device then sends a subset of sensor information to the second user's device based on the information disclosure level selected. The sensor information includes information received from one or more sensors that detect physical attributes of the real-world environment around the first user.

The second user's device may then receive the subset of sensor information from the first device (than could otherwise be optionally shared from the first device), allow the second user to generate content, associate the content with a real-world environmental feature selected from the subset of information, and send both the content and selected real-world environmental feature to the first device. The first device may display the content proximate to the selected real-world environmental feature.

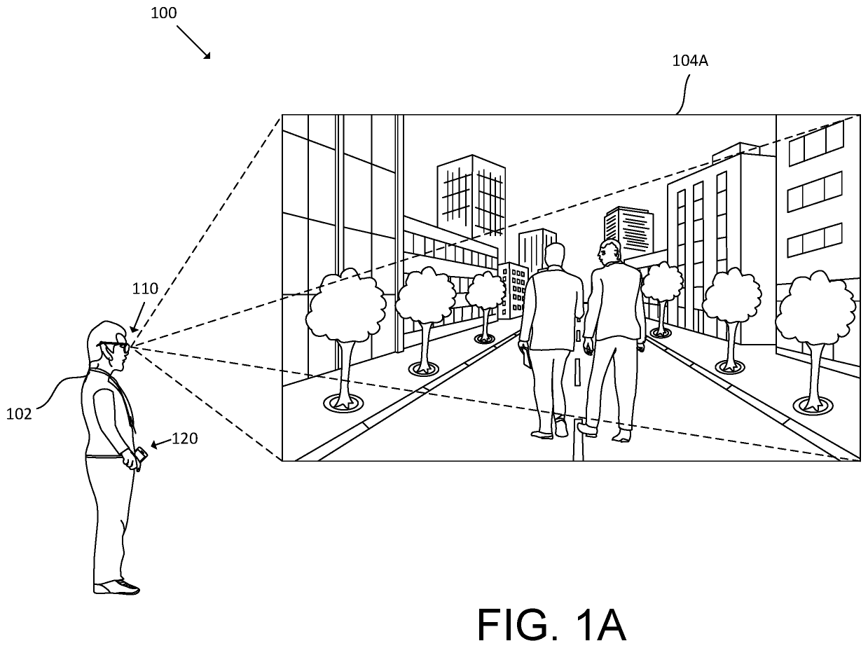

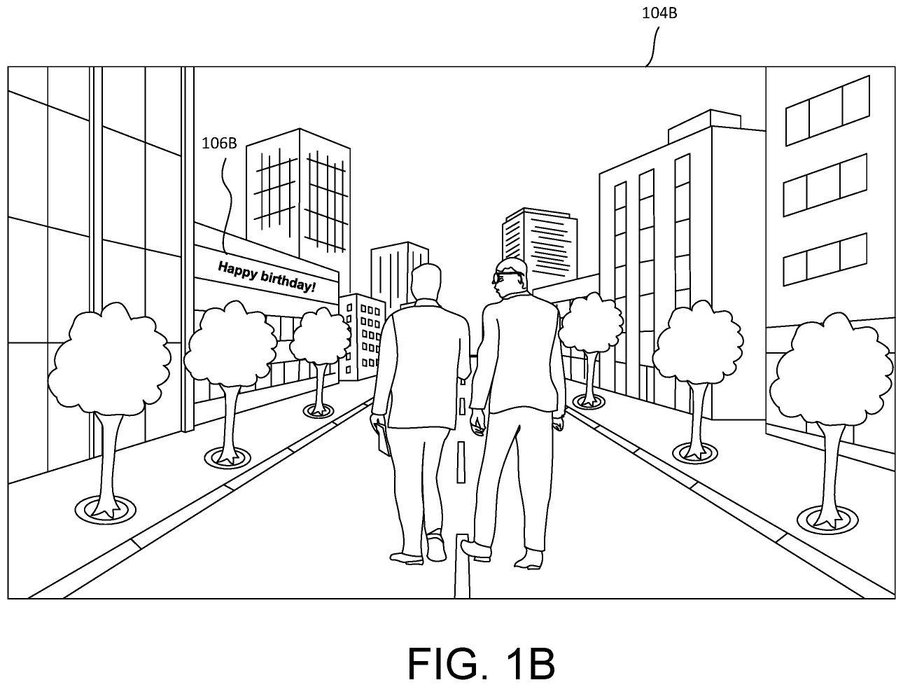

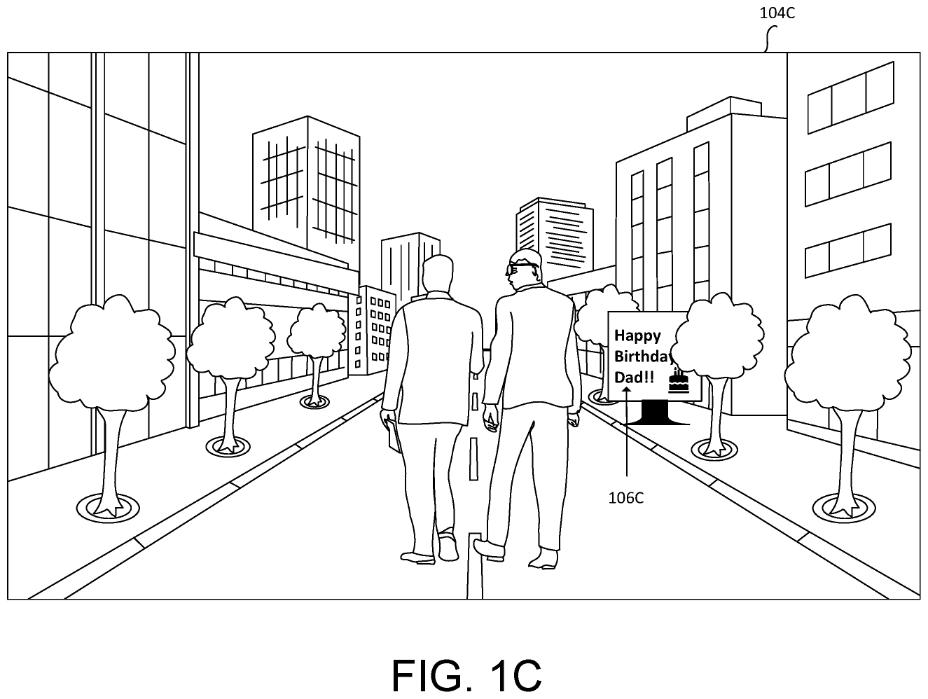

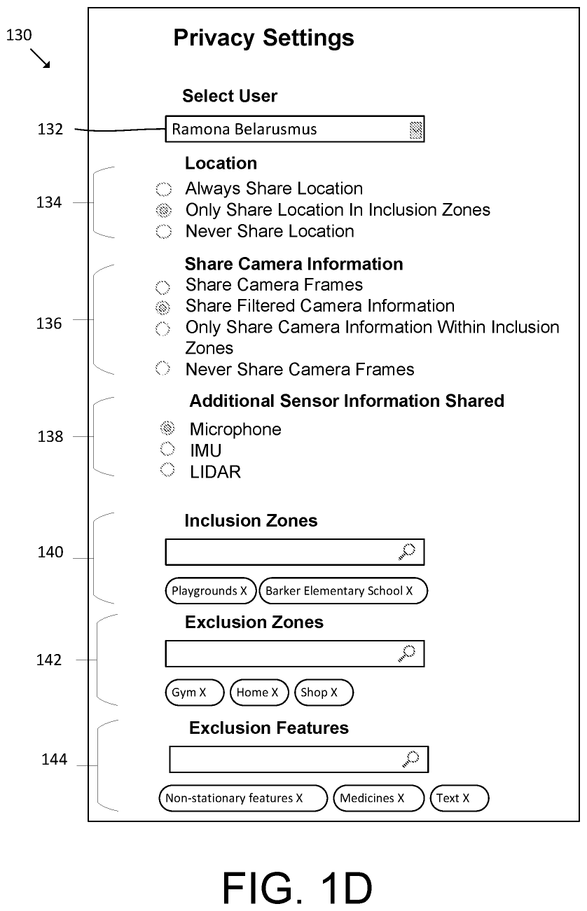

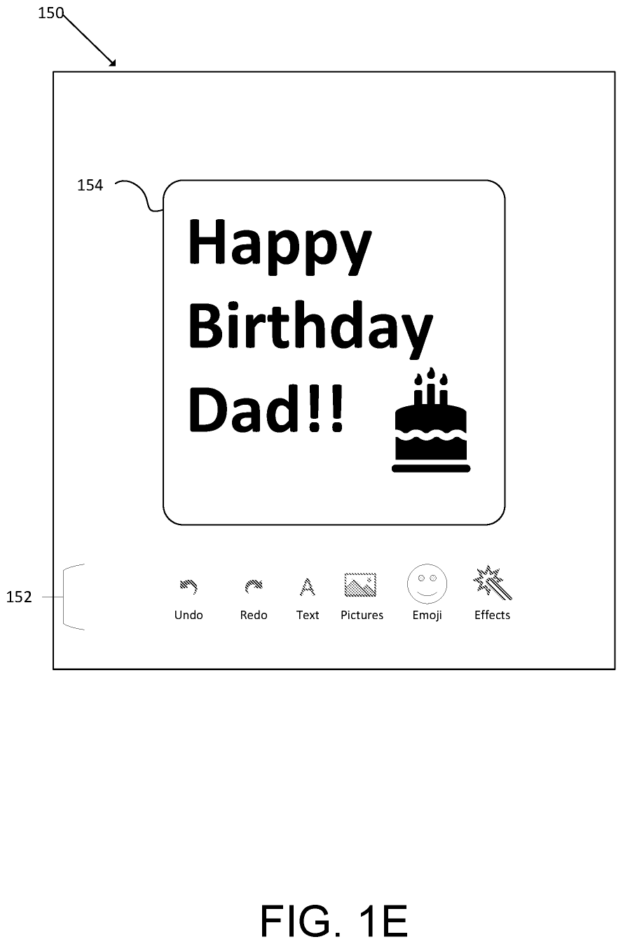

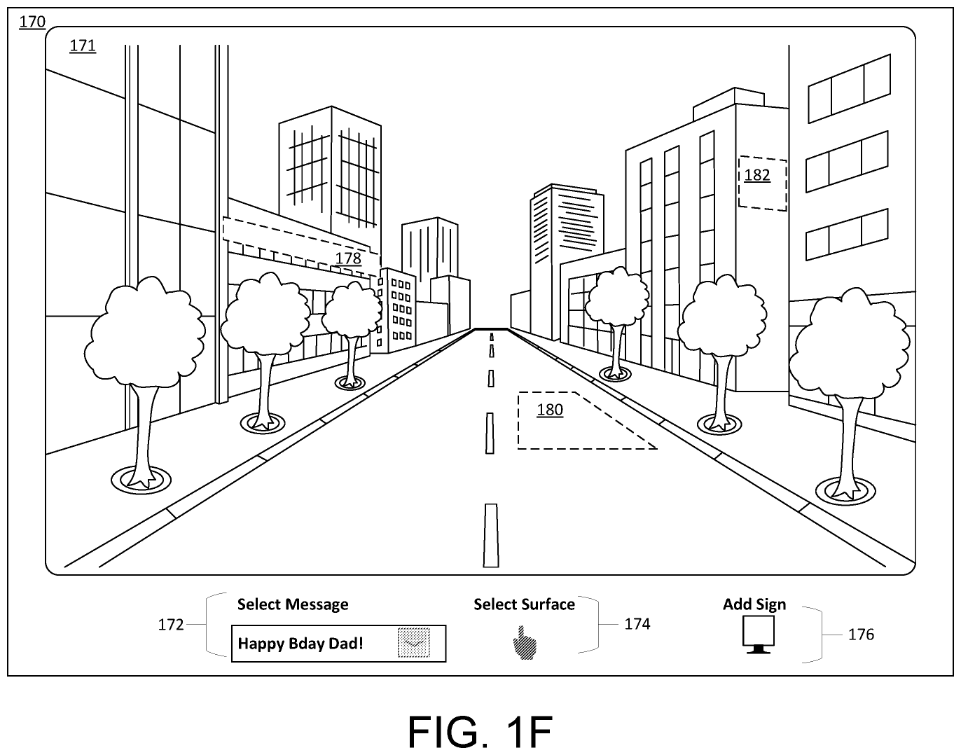

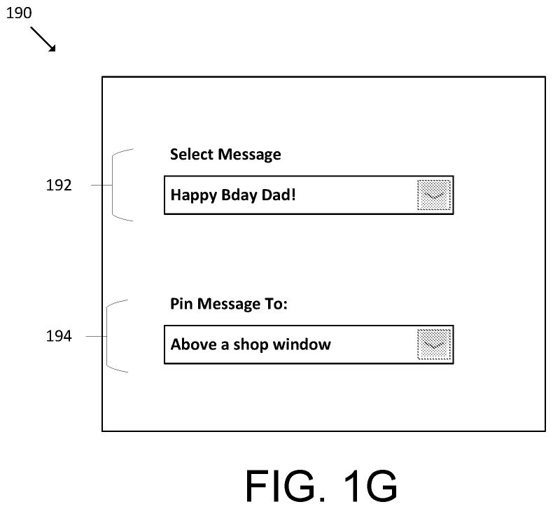

FIG. 1A depicts a scenario 100, in accordance with an example. Scenario 100 includes a first user 102 wearing a head-mounted device 110. In examples, first user 102 may include a further computing device in communication with head-mounted device 110. For example, first user 102 has a smartphone 120 in FIG. 1A.

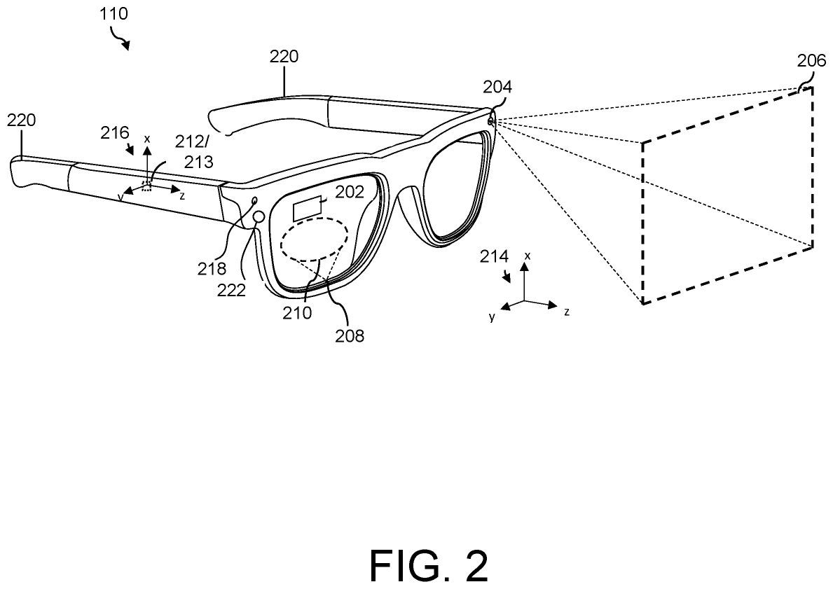

A further detail of head-mounted device 110 is provided in FIG. 2. FIG. 2 depicts a perspective view of a head-mounted device 110 according to an example. As shown, head-mounted device 110 may be implemented as smart glasses (e.g., alternative reality glasses) configured to be worn on a head of a user. Head-mounted device 110 includes a left lens and a right lens coupled to the cars of a user by a left arm and a right arm, respectively. The user may view the world through the left lens and the right lens, which are coupled together by a bridge configured to rest on the nose of the wearer.

Head-mounted device 110 includes a head mounted device display 202, operable to present a display to a user. In examples, head mounted device display 202 may be configured to display information and content (e.g., text, graphics, image) in one or both lenses. Head mounted device display 202 may include all or part of the lens(es) of head-mounted device 110 and may be visually clear or translucent so that when it is not in use the user can view through the display area.

In examples, head-mounted device 110 may include sensing devices configured to help determine where a focus of a user is directed. For example, head-mounted device 110 may include at least one front-facing camera 204. Front-facing camera 204 may be directed forwards to a field-of-view (i.e., field of view 206) or can include optics to route light from field of view 206 to an image sensor. Field of view 206 may include all (or part) of a field-of-view of the user so that images or video of the world from a point-of-view of the user may be captured by front-facing camera 204.

In examples, head-mounted device 110 may further include at least one eye tracking camera. Eye tracking camera 208 may be directed towards an eye field-of-view (i.e., eye field of view 210) or can include optics to route light from eye field of view 210 to an eye image sensor. For example, eye tracking camera 208 may be directed at an eye of a user and include at least one lens to create an image of eye field of view 210 on the eye image sensor.

In examples, head-mounted device 110 may further include at least one inertial measurement unit, or IMU 212. IMU 212 may be implemented as any combination of accelerometers, gyroscopes, and magnetometers to determine an orientation of a head mounted device. IMU 212 may be configured to provide a plurality of measurements describing the orientation and motion of the head mounted display. Data from IMU 212 can be combined with information regarding the magnetic field of the Earth using sensor fusion to determine an orientation of a head mounted device coordinate system 216 with respect to world coordinate system 214. Information from front-facing camera 204, eye field of view 210 and IMU 212 may be combined to determine where a focus of a user is directed, which can enable augmented-reality applications. The head mounted display may further include interface devices for these applications as well.

In examples, head-mounted device 110 may further include a GPS 213. GPS 213 may provide satellite-based coordinates to head-mounted device 110, thereby allowing for geolocation of messages.

In examples, head-mounted device 110 may include a lidar 222. Lidar 222 may provide ranging data that may be used to map the environment around first user 102.

In examples, head-mounted device 110, may include a microphone 218 operable to measure sound. In examples, head-mounted device 110 may include a speaker or a headphone. For example head-mounted device 110 may include headphones 220 that work via bone-conduction or any other method.

Returning to FIG. 1A, it may be seen that first user 102 is observing a field of view 104A through head-mounted device 110. In the example, field of view 104A includes buildings, a street, trees, and two people walking. Head mounted device display 202 of head-mounted device 110 may be used to display geomessages to field of view 104A visible by first user 102.

For example, FIGS. 1B and 1C depict further examples field of view 104B and field of view 104C, respectively. Field of view 104B and field of view 104C each include examples of content. Content 106B is displayed over a surface identified from field of view 104A to generate field of view 104B. Content 106C is displayed within field of view 104C by placing it floating over a sidewalk with a post so that it looks like a sign next to the road that first user 102 is walking down.

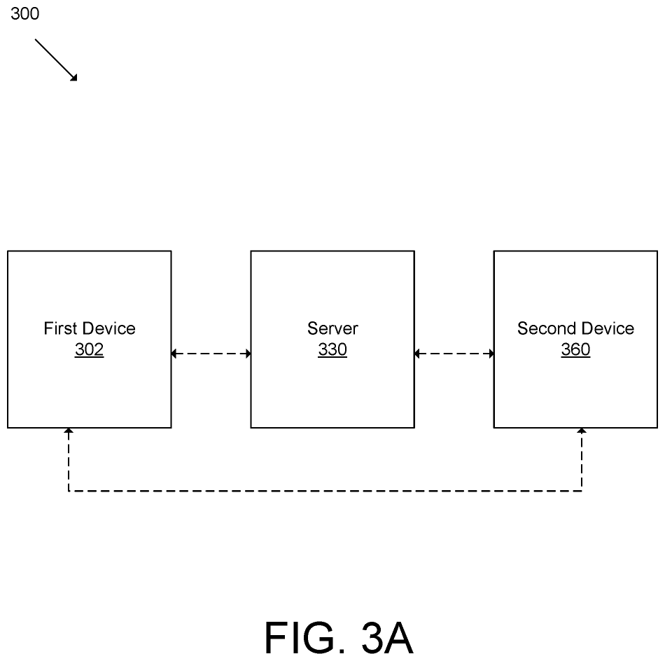

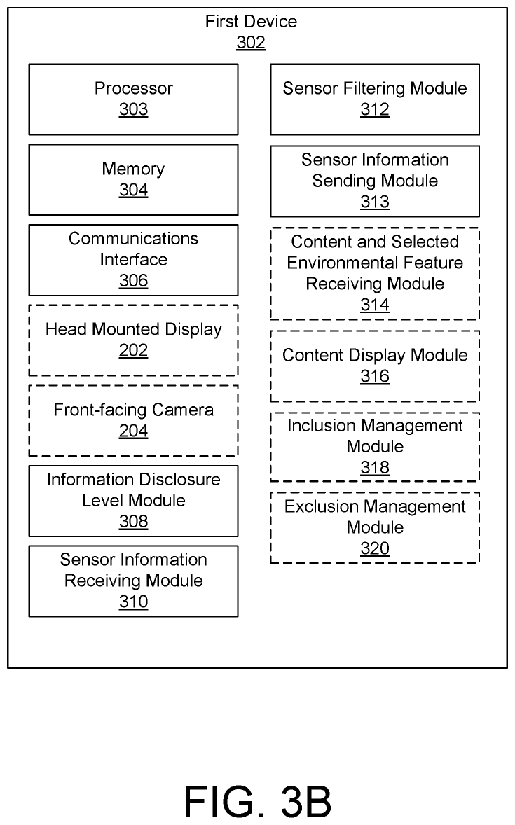

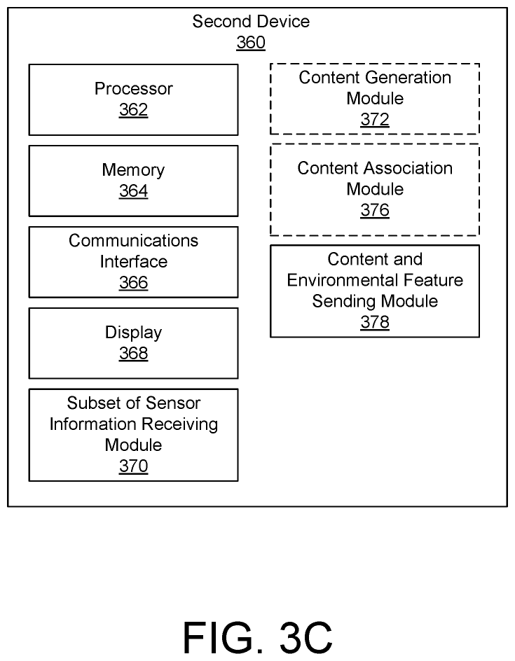

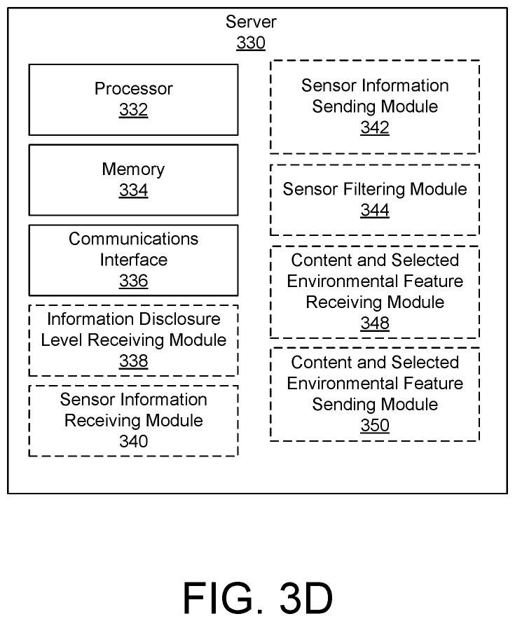

FIG. 3A depicts an example system 300 operable to perform the methods of the disclosure. System 300 includes a first device 302 and a second device 360. First device 302 may communicate directly with second device 360. In examples, system 300 may further include server 330. Server 330 may communicate with second device 360. In examples, server 330 may further communicate with first device 302 and second device 360. The components of system 300 may communicate with one another via any wireless or wired method of communication. In examples, first device 302 and second device 360 may communicate over a local area network. Server 330 may be operable to communicate with first device 302 and server 330 over the Internet.

FIG. 3B depicts a block diagram of first device 302, FIG. 3C depicts a block diagram of second device 360, and FIG. 3D depicts a block diagram of server 330.

In examples, first device 302 may be head-mounted device 110. In the example where first device 302 is head-mounted device 110, the block view of first device 302 in FIG. 3B omits some of the components depicted in FIG. 2 for brevity and clarity. However, first device 302 may include any combination of components depicted in FIGS. 2 and 3B.

In examples, first device 302 may be a smartphone 120 or another device, such as a tablet computer, a laptop, or a desktop computer, communicatively coupled to head-mounted device 110. In the example where first device 302 is another computing device, it may be used to perform the heavier processing described with respect to the disclosure.

First device 302 is depicted in FIG. 3B as processor 303, a memory 304, a communications interface 306, an information disclosure level module 308, a sensor information receiving module 310, a sensor filtering module 312, and a sensor information sending module 313. In examples, first device 302 may further include any combination of: head mounted device display 202, front-facing camera 204, a content and selected real-world environmental feature receiving module 314, a content display module 316, an inclusion management module 318, and an exclusion management module 320.

First device 302 includes a processor 303 and a memory 304. In examples, processor 303 may include multiple processors, and memory 304 may include multiple memories. Processor 303 may be in communication with any cameras, sensors, and other modules and electronics of first device 302. Processor 303 is configured by instructions (e.g., software, application, modules, etc.). The instructions may include non-transitory computer readable instructions stored in, and recalled from, memory 304. In examples, the instructions may be communicated to processor 303 from another computing device via a network via a communications interface 306.

Processor 303 of first device 302 may receive an information disclosure level selected by the first user, receive sensor information, and send a subset of the sensor information to second device 360, as will be further described below.

Communications interface 306 of first device 302 may be operable to facilitate communication between first device 302 and second device 360. In examples, communications interface 306 may utilize Bluetooth, Wi-Fi, Zigbee, or any other wireless or wired communication methods.

Processor 303 of first device 302 may execute information disclosure level module 308. Information disclosure level module 308 may receive an information disclosure level selected by a first user, the information disclosure level relating to at least one sensor recording a real-world physical environment around the first user. In examples, the information disclosure level may include information that may be used to identify what information or data gets filtered out of sensor information from the at least one sensor for inclusion in the subset of sensor information that will be sent to second device 360.

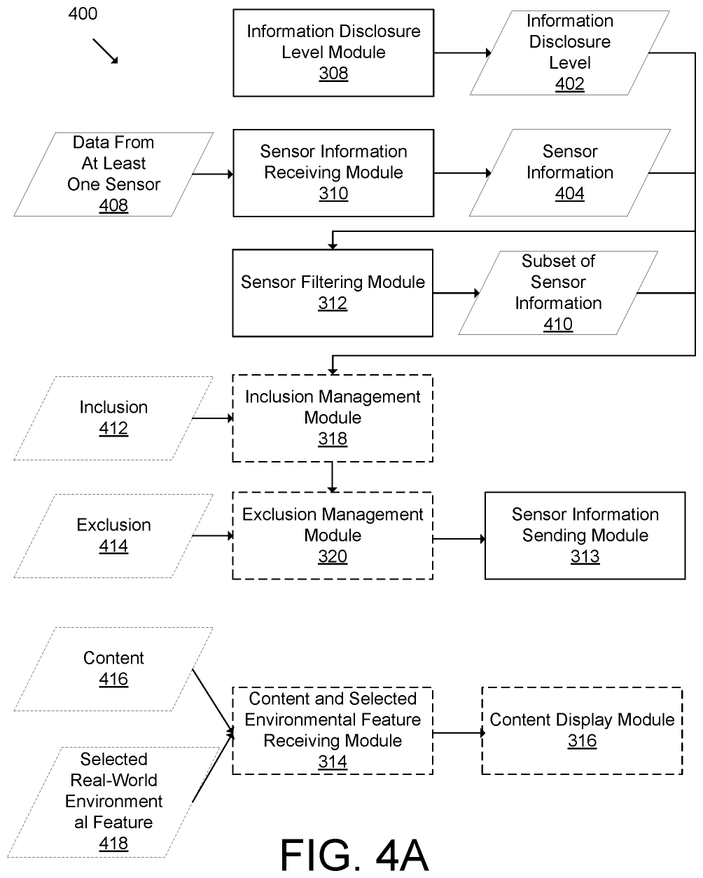

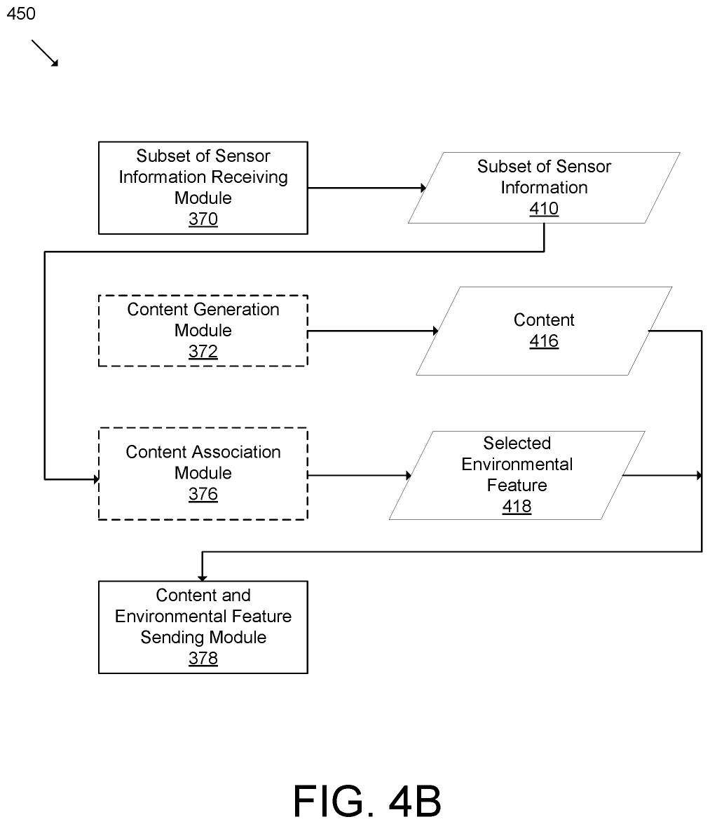

FIG. 4A depicts a block flow diagram 400, according to an example. Flow diagram 400 may be used to generate an information disclosure level, receive and filter sensor information, send it to second device 360, and then receive content and display it adjacent to a selected real-world environmental feature in response.

As may be seen in block flow diagram 400, information disclosure level module 308 receives information disclosure level 402.

In examples, the at least one sensor may include any combination of sensors coupled to or in the environment around first user 102. The at least one sensor must be in communication with first device 302. In examples, the at least one sensor may include any combination of: a camera, a microphone, an inertial measurement unit, a GPS, or a lidar. For example, the at least one sensor may comprise front-facing camera 204, IMU 212, GPS 213, or lidar 222.

In examples, the information disclosure level may include information about what data from the at least one sensor that first user 102 will share or not share. For example, FIG. 1D depicts a privacy settings window 130 depicting user-selectable settings that may be used to determine an information disclosure level. In examples, privacy settings window 130 may appear via head mounted device display 202 of head-mounted device 110 or via another computing device communicatively coupled to head-mounted device 110, such as smartphone 120.

In examples, privacy settings window 130 may include a user selection 132. User selection 132 may allow first user 102 to create custom settings for different users authorized to send geomessages to head-mounted device 110. In the example, user selection 132 is a drop-down box.

In examples, privacy settings window 130 may include a location setting 134. Location setting 134 may allow first user 102 to designate whether a second user selected via user selection 132 may see a location of first user 102. In examples, first user 102 may be able to set location setting 134 to always sharing a location, never sharing a location, or sometimes sharing a location.

In examples, privacy settings window 130 may include a camera information setting 136. Setting 136 may allow first user 102 to designate whether a second user may see a front-facing camera 204 feed from head-mounted device 110. In examples, first user 102 may be able to set setting 136 to share camera frames, share filtered camera frames, to only share camera frames within an inclusion zone, or to never share camera frames.

In examples, privacy settings window 130 may include an additional sensor setting 138. Sensor setting 138 may allow first user 102 to designate whether a second user can access data from at least one sensor. In examples, first user 102 may be able to select any combination of: a microphone, an IMU, or a LIDAR. In examples, sensor setting 138 may allow for further sensors.

In examples, privacy settings window 130 may include an inclusion zone setting 140. Inclusion zone setting 140 may allow first user 102 to designate one or more inclusion zones, or geographic areas within which more sensor information may be shared with at least a second user. In examples, the inclusion zone may designate an area around a specific address or latitude and longitude location. In examples, the inclusion zone may designate a areas within a field of view of a user. In examples, the inclusion zone may designate a place, such as Barker Elementary School or Yosemite National Park. In examples, the inclusion zone may designate a type or classification of place, such as playgrounds.

In examples, privacy settings window 130 may include an exclusion zone setting 142. Exclusion zone setting 142 may allow first user 102 to designate one or more exclusion zones, or geographic areas within which sensor information may not be shared with at least a second user. In examples, the exclusion zone may designate an area around a specific address or latitude and longitude location. In examples, the exclusion zone may designate an areas within a field of view of a user. In examples, exclusion zone setting 142 may allow a user to designate a specific location, such as home, or a class of locations, such as a gym, as an exclusion zone, similar to inclusion zone setting 140 above.

In examples, privacy settings window 130 may include an exclusion feature setting 144. Exclusion feature setting 144 may allow first user 102 to designate a feature or object or categories of features or objects designating sensor information that will be filtered or excluded from the subset of sensor information. In the example of FIG. 1D, a user uses exclusion feature setting 144 to exclude non-stationary features, such as people walking, cars, or animals moving, etc. The example further includes medicines, for example images of pill bottles or ointments. The example also includes the category of text, which could include books, computer screens, and magazines, for example.

Using any of the settings included in privacy settings window 130, a user may prevent the second user from receiving information collected by a sensor, or explicitly provide that information to a user.

In examples, privacy settings window 130 may include further examples of user-selectable settings operable to configure the information disclosure level.

Processor 303 of first device 302 may further execute sensor information receiving module 310. Sensor information receiving module 310 may receive information from at least one sensor. In examples, sensor information receiving module 310 may receive information from the at least one sensor integrated into head-mounted device 110.

For example, as may be seen in FIG. 4A, sensor information receiving module 310 receives data from at least one sensor 408 and generates sensor information 404.

Processor 303 of first device 302 may further execute sensor filtering module 312. Sensor filtering module 312 may filter the sensor information based on the information disclosure level to generate a subset of sensor information. For example, it may be seen in FIG. 4A that sensor filtering module 312 receives sensor information 404 and generates subset of sensor information 410.

In examples, sensor filtering module 312 may filter sensor information to remove information from sensor information 404. For example, sensor filtering module 312 may blur out some information from front-facing camera 204 or receive data from front-facing camera 204 and turn it into a rendering with less detail for the second user to see. In examples, sensor filtering module 312 may receive a precise GPS location and provide a geolocation for first user 102 within a larger area. In other examples, however, sensor filtering module 312 may identify real-world environmental features in the sensor information and send a text-based list of real-world environmental features to the second device.

In examples, subset of sensor information 410 may include any combination of: an object, a surface, a context, a weather type, an event, a lighting, a person, or a location. In examples, the subset of sensor information may include other information as well.

In examples, subset of sensor information 410 information may include an object. The object may comprise any physical thing that can be touched, for example: a football, a car, a shovel, a tree, a house, and so forth. By including information in subset of sensor information 410 about objects, it may be possible for the second user to attach messages to the objects. For example, the second user may attach a geomessage to a car stating, “Don't forget to check the air pressure” or to a football saying, “Good luck at tonight's game!”

In examples, subset of sensor information 410 may include a surface. The surface may comprise any exterior portion of a physical object. For example, a house may include a window surface, a door surface, and a roof surface. FIG. 1F provides examples of surfaces 178, 180, and 182. In examples, a surface may comprise a texture, color, or form. By including information in subset of sensor information 410 about surfaces it may be possible for the second user to attach a geomessage to a certain aspect of a building so the geomessage looks like a shop sign, or to place a geomessage in a grassy area so that it looks like it is growing out of the ground, for example.

In examples, subset of sensor information 410 may include a weather type. The weather type may be sunny, rainy, snowy, and so forth. Including weather information in subset of sensor information 410 may allow the second user to, for example, display a message reminding the first user to take an umbrella if it is raining.

In examples, 410// may include an event. The event could comprise, for example, a sports match, a wedding, a church service, a dinner party, or a birthday party. Including event information in 410// may allow a second user to attach a message, for example, a dinner party reminding the first user to ask if the food includes an ingredient that the first user is allergic to.

In examples, 410// may include a context. For example, the context could comprise a level of brightness, color, contrast, noise, and so forth. Including the context in 410// may allow the second user to associate a geomessage with a backdrop in the first user's field of view where it may be best displayed. For example, a message with white text may be displayed against a dark backdrop for maximum visibility. Or if there appears to be a lot of noise in one section of the first user's field of view, the geomessage may be placed in an area with less noise.

In examples, 410// may include a person. In examples, the person may be identified by name or other identifier, by size, by age, and so forth. In examples, by including a person in 410//, it may be possible for the second user to associate content with someone. For example, the second user may be able to associate a business card with a person in the first user's field of view.

In examples, 410// may include a location. The location may comprise an address, a location type (playground, coffee shop, hardware store, national park, etc.), a latitude and longitudinal location, and so forth. Including a location in 410// may allow the second user to send a geomessage when, for example, the first user is in a national park parking lot to wear mosquito repellant.

Processor 303 of first device 302 may further execute sensor information sending module 313. Sensor information sending module 313 may be configured to send the subset of sensor information to the second device. This may allow second device 360 to select a real-world environmental feature to associate the content with.

Processor 303 of first device 302 may further execute content and selected real-world environmental feature receiving module 314. Selected real-world environmental feature receiving module 314 may receive a content and a selected real-world environmental feature from the second device based on the subset of sensor information. For example, as may be seen in FIG. 4A, sensor information sending module 313 may receive subset of sensor information 410 and send it to second device 360.

In examples, processor 303 may execute any combination of inclusion management module 318 or exclusion management module 320 before sensor information sending module 313.

Processor 303 of first device 302 may further execute inclusion management module 318. Inclusion management module 318 may receive an inclusion 412, as depicted in FIG. 4A. In examples, inclusion may include one or more locations, circumstances, or contexts when first user 102 may be willing to share data from subset of sensor information 410. For example, as may be seen in block flow diagram 400, inclusion management module 318 receives an inclusion 412. In examples, subset of sensor information 410 may only be sent to second device 360 upon determining that subset of sensor information 410 is related to inclusion 412.

For example, as depicted in FIG. 1D, privacy settings window 130 may include inclusion zone setting 140. In the example, playgrounds and Barker Elementary School are included.

Processor 303 of first device 302 may further execute exclusion management module 320. Exclusion management module 320 may receive an exclusion. For example, as may be seen in FIG. 4A, exclusion management module 320 receives an exclusion 414. Like inclusion 412, exclusion 414 may include one or more locations, circumstances, or contexts. Exclusion 414 may indicate conditions where first user 102 is not willing to share subset of sensor information 410. In examples, subset of sensor information 410 may only be sent to second device 360 upon determining that subset of sensor information 410 is not related to exclusion 414.

For example, as depicted in FIG. 1D, privacy settings window 130 may include exclusion zone setting 142. In the example, the gym, home, and shops are listed as exclusions.

Processor 303 of first device 302 may further execute content display module 316. Content display module 316 may display the content in a field of view proximate to the selected real-world environmental feature. For example, FIG. 1B depicts content 106B, which is text that reads, “Happy Birthday!?” Content 106B has been positioned on a surface of a building so that it looks like a shop sign.

FIG. 3C depicts a block view of second device 360. Second device 360 may be used to allow a second user to create content and associate it with a selected real-world environmental feature for display with head-mounted device 110.

FIG. 4B depicts a block flow diagram 450, according to an example. Flow diagram 450 may be used to generate a content and selected real-world environmental features based on a subset of sensor information to send back to first device 302 for display. Second device 360 includes a processor 362, a memory 364, a communications interface 366, a display 368, a subset of sensor information receiving module 370, a content generating module 372, a content association module 376, and a content and real-world environmental feature sending module 378.

In examples, processor 362, memory 364, and communications interface 366 may be similar to processor 303, memory 304, and communications interface 306, respectively.

Processor 362 of second device 360 may execute subset of sensor information receiving module 370. Subset of sensor information receiving module 370 may receive subset of sensor information 410 over communications interface 366, for example, as may be seen in FIG. 4B.

Processor 362 of second device 360 may execute content generating module 372. Content generating module 372 may be used to generate content that may be sent to first device 302 for display via head mounted device display 202.

This may be seen in FIG. 4B, which depicts content generating module 372 generating a content 416.

In examples, content generating module 372 may execute a content generation module with user-selectable settings operable to generate content 416. For example, FIG. 1E depicts an example a content generation window 150. Content generation window 150 includes user-selectable settings 152 to generate a content 154. In the example, user-selectable settings 152 include an undo and redo setting, a setting to add text, a setting to add pictures, a setting to add emoji, and a setting for general effects. However, user-selectable settings 152 may include any possible settings operable to create content that may be displayed before first user 102, including adding video, audio, or any photo or illustration modifications.

In FIG. 1E, a user has used content generation window 150 to select settings that create a text message with an icon of a birthday cake.

Processor 362 of second device 360 may further execute content association module 376. Content association module 376 may include user-selectable settings operable to determine the selected real-world environmental feature from the subset of sensor information. For example, in FIG. 4B it may be seen that content association module 376 receives subset of sensor information 410 and generates selected real-world environmental feature 418.

For example, FIG. 1F depicts a content association window 170. Content association window 170 includes a display 171 where the second user may select an real-world environmental feature from subset of sensor information 410 displayed. In the example, display 171 includes an image including a subset of information from view 104A, which was observed with front-facing camera 204 of head-mounted device 110 represented in FIG. 1A. As may be seen, the static elements from view 104A are displayed in display 171, including the buildings, the road, the sidewalks, and the trees. Subset of sensor information 410 used to generate display 171 includes only the static elements of data from sensor information 404, not the moving elements, which included two people walking. By removing the non-static elements from sensor information 404, this may help provide only the most relevant surfaces for a second user to associate content 416 with for display for first user 102.

In examples, subset of sensor information 410 may be received at second device 360 in the form of a three-dimensional rendering. In examples, first device 302 or server 330 may identify one or more components from sensor information 404, such as buildings, trees, streets, people, and generate a 3D rendering of subset of sensor information 410. In other examples, however, first device 302 or server 330 may determine a location of first device 302 and use geospatial data from a database to generate a 3D rendering of the location.

In examples, subset of sensor information 410 may be received at second device 360 in the form of a clay rendering. The clay rendering may remove some information from view 104A, for example texture and other details. In examples, the clay rendering may just provide the broad outlines of static components of view 104A, generating an image without texture. For example, FIG. 1F depicts a clay rendering of scenario 100.

As may be seen, content association window 170 may include one or more user-selectable settings. In examples, a message selection setting 172 may allow the second user to select which content to post. In examples, a surface selection setting 174 may allow the second user to select a surface to post the content on. For example, content association window 170 has identified example surfaces 178, 180, and 182, which are outlined in broken lines. For example, in FIG. 1B, it may be seen that content 106B has been displayed on surface 178 using head mounted device display 202.

In examples, content association window 170 may include a sign setting 176. Sign setting 176 may allow a user to generate a virtual sign that may be posted somewhere in display 171. For example, in FIG. 1C, it may be seen that content 106C is posted in the form of a virtual sign.

In examples, a selected real-world environmental feature 418 may be selected from a list of real-world environmental features comprising a portion of subset of sensor information 410. For example, FIG. 1G depicts a content association window 190, in accordance with an example. Content association window 190 includes a message selection setting 192 and a real-world environmental feature selection setting 194. In examples, real-world environmental feature selection setting 194 may include real-world environmental features identified in subset of sensor information 410. In further examples, however, environmental feature selection setting 194 may include a generic set of environmental features that first user 102 may be likely to encounter, such as a gas station or a tree. In further examples, however, environmental feature selection setting 194 may include set of features that can be created and displayed by head mounted device display 202. In either case, content association window 190 allows the second user to associate content 416 with selected real-world environmental feature 418.

Processor 362 of second device 360 may further execute content and environmental feature sending module 378. Content and environmental feature sending module 378 may send the content to the first device for display in proximity to the selected real-world environmental feature identified from the subset of sensor information. For example, as may be seen in FIG. 4B, module 378 may receive content 416 and selected real-world environmental feature 418 and send it to first device 302 for display on head mounted device display 202.

FIG. 3D depicts a more detailed block view of server 330. Server 330 may be used to perform any of the processing described with respect to first device 302 and or second device 360.

Server 330 includes a processor 332, a memory 334, and a communications interface 336. In examples, server 330 may further include an information disclosure level receiving module 338, a sensor information receiving module 340, a sensor information sending module 342, a sensor filtering module 344, a content and selected real-world environmental feature receiving module 348, and a content and selected real-world environmental feature sending module 350.

In examples, processor 332, memory 334, and communications interface 336 may be similar to processor 303, memory 304, and communications interface 306, respectively.

Processor 332 of server 330 may execute information disclosure level receiving module 338. In examples, information disclosure level receiving module 338 may operate similar to information disclosure level module 308, as described above. Processor 332 of server 330 may execute sensor information receiving module 340. In examples, sensor information receiving module 340 may operate similar to sensor information receiving module 310 described above.

Processor 332 of server 330 may execute sensor information sending module 342. In examples, sensor information sending module 342 may operate similar to sensor information sending module 313 above.

Processor 332 of server 330 may execute sensor filtering module 344. In examples, sensor filtering module 344 may operate similar to sensor filtering module 312 described above.

Processor 332 of server 330 may execute content and selected real-world environmental feature receiving module 348. In examples, module 348 may operate similar to module 314 described above.

Processor 332 of server 330 may execute content and selected real-world environmental feature sending module 350. In examples, content and selected real-world environmental feature sending module 350 may operate similar to module 378 described above.

The disclosure describes a way for a user to receive customized geomessages, or content associated with real-world environmental features around the user, while allowing that user to have a large degree of privacy about what can be seen or learned about the environment around the user receiving the messages.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a computing device, wherein the memory is further configured with instructions to: receive a content from the second device; receive a selected real-world environmental feature from the second device based on the subset of sensor information; and display the content in a field of view proximate to the selected real-world environmental feature.

In some aspects, the techniques described herein relate to a computing device, wherein the at least one sensor includes a global positioning system, the information disclosure level includes an exclusion zone, and filtering the sensor information based on the information disclosure level further includes filtering the sensor information to remove data within the exclusion zone to generate the subset of sensor information.

In some aspects, the techniques described herein relate to a computing device, wherein the at least one sensor includes a global positioning system, the information disclosure level includes an inclusion zone, and filtering the sensor information based on the information disclosure level further includes filtering the sensor information to remove data within the inclusion zone to generate the subset of sensor information.

In some aspects, the techniques described herein relate to a computing device, wherein the at least one sensor includes at least one of a lidar or a camera, the information disclosure level includes at least one exclusion feature, and filtering the sensor information based on the information disclosure level further includes filtering the sensor information to remove data related to the exclusion feature to generate the subset of sensor information.

In some aspects, the techniques described herein relate to a computing device, wherein receiving the content further includes: execute a content generation module with user-selectable settings operable to generate the content.

In some aspects, the techniques described herein relate to a computing device, wherein receiving the content further includes: execute a content association module with user-selectable settings operable to determine the selected real-world environmental feature from the subset of sensor information.

In some aspects, the techniques described herein relate to a computing device, wherein receiving the subset of sensor information from the first device further includes: receiving a three-dimensional rendering of the subset of sensor information.

In some aspects, the techniques described herein relate to a computing device, wherein the three-dimensional rendering of the subset of sensor information is a clay rendering.

In some aspects, the techniques described herein relate to a computing device, wherein the selected real-world environmental feature may be selected from a list of real-world environmental features including a portion of the subset of sensor information.

In some aspects, the techniques described herein relate to a computing device or claim 5, wherein the subset of sensor information includes at least one of: an object, a surface, a context, a weather type, an event, a person, or a location.

In some aspects, the techniques described herein relate to a computing device, wherein the at least one sensor includes any combination of: a camera, a microphone, an inertial measurement unit, a global positioning system, or a lidar.

In some aspects, the techniques described herein relate to a method, wherein sending the subset of sensor information to the second device further includes: generating a rendering of the subset of sensor information.

In some aspects, the techniques described herein relate to a method, wherein the subset of sensor information includes a location and the rendering of the subset of sensor information is generated based on a database of geospatial data for the location.

In some aspects, the techniques described herein relate to a method, wherein the subset of sensor information is a list of environmental features.

In some aspects, the techniques described herein relate to a method, further including: receiving a content from the second device; receiving a selected real-world environmental feature from the second device based on the subset of sensor information; and sending the content and the selected real-world environmental feature to a first device.

In some aspects, the techniques described herein relate to a method, wherein the subset of sensor information includes at least one of: an object, a surface, a context, a weather type, an event, a person, or a location.

What is claimed is:

1. A computing device comprising:
a processor; and
a memory configured with instructions to:
receive an information disclosure level selected by a user, the information disclosure level relating to at least one sensor recording a real-world environment around the user;
receive sensor information from the at least one sensor;
filter the sensor information based on the information disclosure level to generate a subset of sensor information; and
send the subset of sensor information to a second device.

2. The computing device of claim 1, wherein the memory is further configured with instructions to:
receive a content from the second device;
receive a selected real-world environmental feature from the second device based on the subset of sensor information; and
display the content in a field of view proximate to the selected real-world environmental feature.

3. The computing device of claim 1, wherein the at least one sensor includes a global positioning system, the information disclosure level includes an exclusion zone, and filtering the sensor information based on the information disclosure level further comprises filtering the sensor information to remove data within the exclusion zone to generate the subset of sensor information.

4. The computing device of claim 1, wherein the at least one sensor includes a global positioning system, the information disclosure level includes an inclusion zone, and filtering the sensor information based on the information disclosure level further comprises filtering the sensor information to remove data within the inclusion zone to generate the subset of sensor information.

5. The computing device of claim 1, wherein the at least one sensor includes at least one of a lidar or a camera, the information disclosure level includes at least one exclusion feature, and filtering the sensor information based on the information disclosure level further comprises filtering the sensor information to remove data related to the at least one exclusion feature to generate the subset of sensor information.

6. The computing device of claim 1, wherein the subset of sensor information includes at least one of: an object, a surface, a context, a weather type, an event, a person, or a location.

7. The computing device of claim 1, wherein the at least one sensor comprises any combination of: a camera, a microphone, an inertial measurement unit, a global positioning system, or a lidar.

8. A computing device comprising:
a processor; and
a memory configured with instructions to:
receive a subset of sensor information from a first device, the subset of sensor information being based on at least one sensor proximate to a first device and an information disclosure level;
receive a content generated by a user;
receive a selected real-world environmental feature identified from the subset of sensor information by the user; and
send the content to the first device for display in proximity to the selected real-world environmental feature identified from the subset of sensor information.

9. The computing device of claim 8, wherein receiving the content further comprises:
execute a content generation module with user-selectable settings operable to generate the content.

10. The computing device of claim 8, wherein receiving the content further comprises:
execute a content association module with user-selectable settings operable to determine the selected real-world environmental feature from the subset of sensor information.

11. The computing device of claim 8, wherein receiving the subset of sensor information from the first device further comprises:
receiving a three-dimensional rendering of the subset of sensor information.

12. The computing device of claim 11, wherein the three-dimensional rendering of the subset of sensor information is a clay rendering.

13. The computing device of claim 11, wherein the selected real-world environmental feature may be selected from a list of real-world environmental features comprising a portion of the subset of sensor information.

14. The computing device of claim 8, wherein the subset of sensor information includes at least one of: an object, a surface, a context, a weather type, an event, a person, or a location.

15. The computing device of claim 8, wherein the at least one sensor comprises any combination of: a camera, a microphone, an inertial measurement unit, a global positioning system, or a lidar.

16. A method, comprising:
receiving an information disclosure level selected by a user from a first device;
receiving sensor information from at least one sensor from the first device; and
sending a subset of sensor information to a second device based on the sensor information and the information disclosure level.

17. The method of claim 16, wherein sending the subset of sensor information to the second device further comprises:
generating a rendering of the subset of sensor information.

18. The method of claim 17, wherein the subset of sensor information includes a location and the rendering of the subset of sensor information is generated based on a database of geospatial data for the location.

19. The method of claim 17, wherein the subset of sensor information is a list of environmental features.

20. The method of claim 17, further comprising:
receiving a content from the second device;
receiving a selected real-world environmental feature from the second device based on the subset of sensor information; and
sending the content and the selected real-world environmental feature to a first device.

21. The method of claim 16, wherein the subset of sensor information includes at least one of: an object, a surface, a context, a weather type, an event, a person, or a location.
